(19) United States
(12) Patent Application Publication
(10) Pub. No.: US 2018/0038249 A1
(43) Pub. Date: Feb. 8, 2018

(54) MUFFLER WITH VENTURI EXHAUST LINE

(71) Applicant: Gibson Performance Corp., Corona, CA (US)

(72) Inventors: Shawn Leroy Gibson, Corona, CA (US); Gary Alan Williams, Corona, CA (US)

(21) Appl. No.: 15/336,451

(22) Filed: Oct. 27, 2016

Related U.S. Application Data
(60) Provisional application No. 62/371,648, filed on Aug. 5, 2016.

(51) Int. Cl. F01N 1/08; G10K 11/172; G10K 11/16

(52) U.S. Cl. CPC F01N 1/083; G10K 11/161; G10K 11/172

(57) ABSTRACT

Disclosed is a system for noise reduction including a tubular conduit and an exterior shell disposed about the tubular conduit. The tubular conduit can include a first section configured to be fluidly connected to an engine to allow exhaust gas to pass through the first section. The first section can include a plurality of openings. The tubular conduit can include a second section that is fluidly connected to the first section and is configured to accelerate the velocity of exhaust gas and decrease the pressure within the second tubular section. The second section can include a tube with a first tapered section that reduces in diameter, a second tubular section with a plurality of openings, and a third reverse-tapered section that expands in diameter. The tubular conduit can include a third section configured to be fluidly connected to the second section. The third section can include a plurality of openings.

### CROSS-REFERENCE TO RELATED APPLICATIONS

This application claims the benefit of U.S. Provisional Patent Application No. 62/371,648, filed Aug. 5, 2016 which is hereby incorporated by reference in its entirety.

### BACKGROUND

### Field

The present disclosure relate to exhaust lines that can be installed in mufflers to be used in vehicles such a motorcycles and cars.

### Description of the Related Art

Exhaust lines guide exhaust gas from the engine of a vehicle to the outside air. A muffler can be mounted about the exhaust line to alter the sound of the air leaving the engine. As well, the performance of the exhaust line of the vehicle can affect the performance of the engine.

### SUMMARY

Certain aspects of the present disclosure are directed toward an exhaust line, for example a venturi exhaust line that can be used in a muffler can.

The exhaust line directs exhaust gas from the engine of a vehicle to the outside air. A muffler can be mounted about the exhaust line to alter the sound of the exiting exhaust gas—frequently to soften the sound of the exiting gas. The design of the exhaust line within a muffler can serve two purposes: (1) to control the movement of sound waves within the muffler to produce a desired sound and (2) to prevent cold air from being sucked into the exhaust pipe which can cause a resonance and vibration.

To encourage the flow of exhaust gas within the muffler can, the exhaust line can include a narrowed tube portion that generates a venturi effect on the exhaust gas. This venturi core can encourage the cycling of exhaust gas within the muffler to create a sound cancelling effect which not only causes a reduction in overall sound volume, but creates a fine-tuned output tone that is rich with pleasant, low-frequency notes. In other examples, the venturi core can accelerate the exhaust gas passing through the exhaust line. The design of the venturi core can also create a vacuum to suck escaped exhaust gas from the space within the muffler around the exhaust line into the exhaust line again. This design can prevent cold air from being sucked into the exhaust line when the accelerator pedal is released.

In some examples, the exhaust line and the venturi core can include openings that encourage the flow of air through the muffler can. The exhaust line can have an offset design to fit around the frame (e.g. the chassis) of the vehicle.

In some embodiments, disclosed is a system for noise reduction that comprises a tubular conduit. The tubular conduit can include a first section comprising a tube with a first end and a second end and a plurality of openings spaced about the second end of the tube. The first section can be configured to be fluidly connected to an engine to allow exhaust gas to pass through the first section. In some embodiments, the tubular conduit comprises a second section comprising a tube with a first tapered section that reduces in diameter, a second tubular section with a plurality of openings, and a third reverse-tapered section that expands in diameter. The second section can be fluidly connected to the second end of the first section and is configured to accelerate the velocity of exhaust gas and decrease the pressure within the second tubular section such that exhaust gas can be drawn into the second section. In some embodiments, the tubular conduit comprises a third section comprising a tube with a first end and a second end and a plurality of openings spaced about the first end of the tube. The third section can be configured to be fluidly connected to the second section to allow exhaust gas to pass through the third section.

In some embodiments, the system for noise reduction can comprise an exterior shell disposed about the tubular conduit. In some embodiments, the exterior shell can include a first cap with an opening, wherein the first cap is configured to attach to a first end of the exterior shell and is configured to retain the first section of the tubular conduit. The exterior shell can include a second cap with an opening, wherein the second cap is configured to attach to a second end of the exterior shell and is configured to retain the second section of the tubular conduit.

Disclosed also is a method for noise reduction. In some embodiments, the method can include flowing air through a tubular conduit that extends through an exterior shell attached about the exterior surface of the tubular conduit, wherein the tubular conduit includes a first tubular section, a second tubular section, and a third tubular section. The method can include flowing air through the first tubular section comprising a first end and a second end and a plurality of openings spaced about the second end of the tube. The method can include creating a pressure drop in the second tubular section that is fluidly connected to the first tubular section, wherein a portion of the second tubular section has a reduced diameter and a plurality of openings. The method can include flowing air through the third tubular section comprising a first end and a second end and a plurality of openings spaced about the first end of the tube, wherein the first end of the third tubular section is fluidly connected to the second tubular section. The method can include causing air to flow out of the plurality of openings in the first tubular section. The method can include causing air to flow into the plurality of openings in the second tubular section as a result of the pressure drop within the second tubular section. The method can include causing air to flow into the plurality of openings in the third tubular section. The method can include bouncing soundwaves against the inner surface of the exterior shell to create counterwaves that cause sound cancellation. The method can include forcing air out of the second end of the third tubular section.

### BRIEF DESCRIPTION OF THE DRAWINGS

Various embodiments are depicted in the accompanying drawings for illustrative purposes, and should not be interpreted as limiting the scope of the embodiments. Furthermore, various features of different disclosed embodiments can be combined to form additional embodiments, which are part of this disclosure

FIG. 1 illustrates one embodiment of an exhaust line with a venturi core.

FIGS. 2A-2C illustrate a plurality of views of the venturi core of the exhaust line illustrated in FIG. 1.

FIGS. 3A-3D illustrate a plurality of views of the exhaust tubes of the exhaust line of FIG. 1.

FIGS. 4A-4C illustrate a plurality of views of the muffler can that can be mounted about the exhaust line of FIG. 1.

FIG. 4D illustrates a schematic drawing of the flow of exhaust gas through a cross-section of the exhaust line.

FIG. 4E illustrates another schematic drawing of the flow of exhaust gas through a cross-section of the exhaust line when the exhaust gas is moving at a low speed.

FIG. 4F illustrates another schematic drawing of the flow of exhaust gas through a cross-section of the exhaust line when the exhaust gas is moving at a high speed.

FIG. 5A illustrates a side view of an embodiment of an exhaust line with offset exhaust tubes and the venturi core of FIGS. 2A-2C.

FIG. 5B illustrates a side view of an embodiment of the offset exhaust tubes of the exhaust line of FIG. 5A.

FIGS. 5C-5E illustrate a plurality of views of an embodiment of a muffler can that can be mounted about the exhaust line with offset exhaust tubes of FIG. 5A.

FIG. 6A illustrates a side view of another embodiment of an exhaust line with offset exhaust tubes and the venturi core of FIGS. 2A-2C.

FIG. 6B illustrates a side view of an embodiment of the offset exhaust tubes of the exhaust line of FIG. 6A.

FIGS. 6C-6E illustrate a plurality of views of an embodiment of a muffler can that can be mounted about the exhaust line with offset exhaust tubes of FIG. 6A.

FIG. 7A illustrates a side view of another embodiment of an exhaust line with offset exhaust tubes and the venturi core of FIGS. 2A-2C.

FIGS. 7B-7D illustrate a plurality of view of the offset exhaust tubes of the exhaust line of FIG. 7A.

### DETAILED DESCRIPTION

Various exhaust line, muffler assemblies, and methods for assembling the aforementioned are disclosed to illustrate various examples that may be employed to achieve one or more desired improvements. For purposes of presentation, certain embodiments are disclosed with respect to a muffler, but the disclosed invention can be used in other contexts as well. Indeed, the described embodiments are examples only and are not intended to restrict the general disclosure presented and the various aspects and features of this disclosure. The general principles described herein may be applied to embodiments and applications other than those discussed herein without departing from the spirit and scope of the disclosure. This disclosure should be accorded the widest scope consistent with the principles and features that are disclosed or suggested herein.

Although certain aspects, advantages, and features are described herein, it is not necessary that any particular embodiment include or achieve any or all of those aspects, advantages, and features. For example, some embodiments may not achieve the advantages described herein, but may achieve other advantages instead. No feature, component, or step is necessary or critical.

### Overview

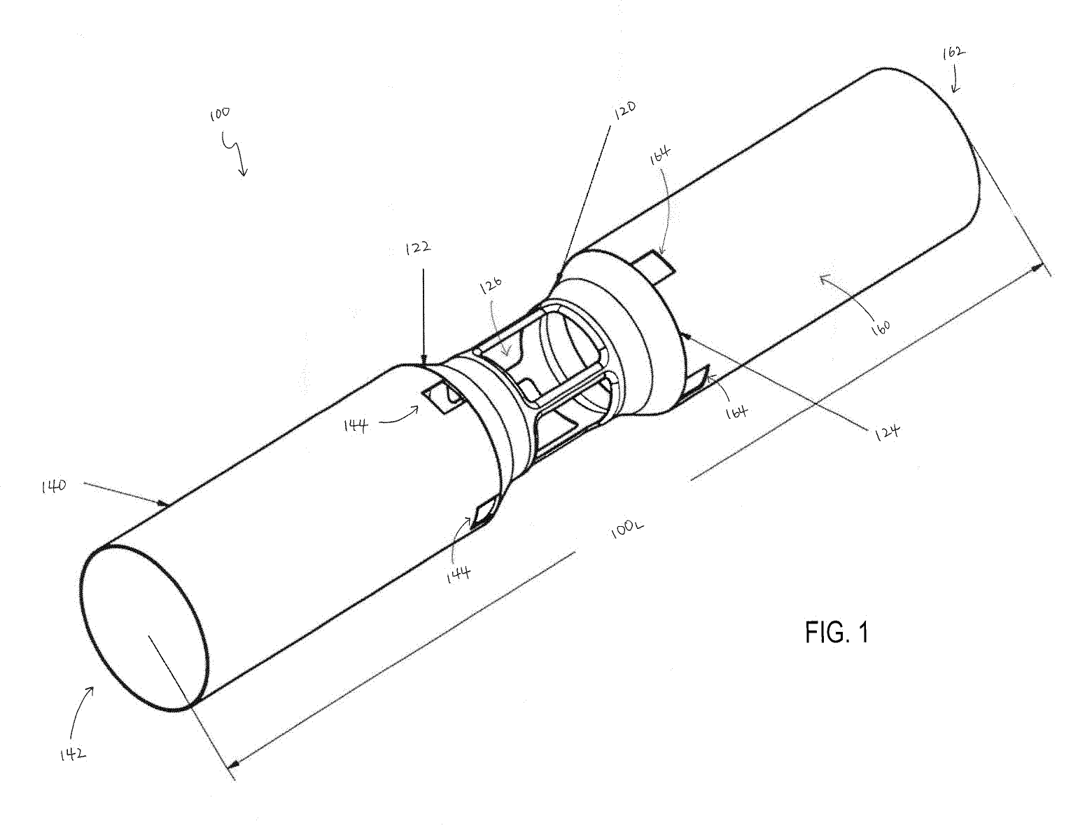

FIG. 1 illustrates an embodiment of an exhaust tube 100 that can be attached to the engine of a vehicle to guide exhaust gas from the exhaust air. The exhaust tube 100 includes a first exhaust tube 140 a venturi core 120 and a second exhaust tube 160. The first exhaust tube 140 can include a input end 142 that can be fluidly connected to the engine to provide for the outflow of exhaust gas. The first exhaust tube 140 is attached to the venturi core 120 at the venturi input end 122 and is fluidly connected to the venturi core 120 such that exhaust gas can flow from the first exhaust tube 140 into the second exhaust tube 160. The venturi core 120 can then be fluidly connected to the second exhaust tube 160 at the venturi exit end 124 such that the exhaust gas can flow from the venturi core 120 into the second exhaust tube 160. The exhaust gas can then exit from the exhaust tube 100 through the exit end 162.

In some embodiments, the first exhaust tube 140 and second exhaust tube 160 can be identical and include a plurality of openings 144 and openings 164. As will be discussed in more detail below, the openings 144 and openings 164 provide for the circulation of exhaust gas out of, and into, the exhaust tube 100.

As is illustrated in FIG. 1, the exhaust tube 100 can include a venturi core 120. In some examples, the venturi core 120 is located between the first exhaust tube 140 and the second exhaust tube 160. In some embodiments, the second exhaust tube 160 can be located around the midsection of the length of exhaust tube 100L. The Length of exhaust tube 100L can be 20.00±0.25 inches.

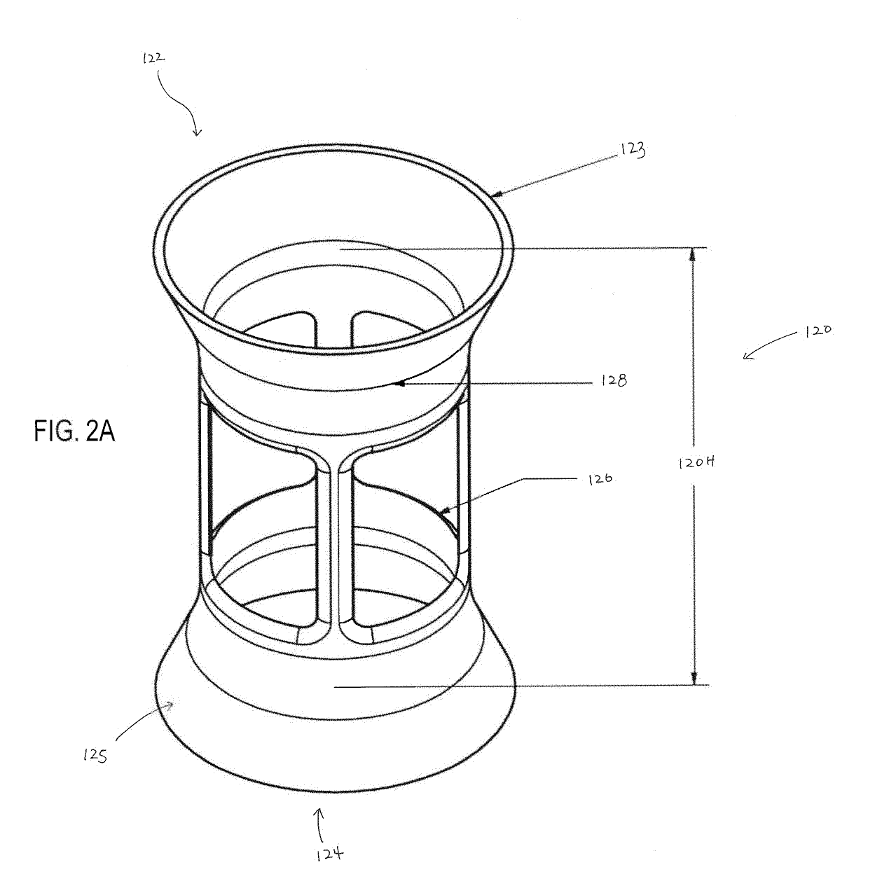

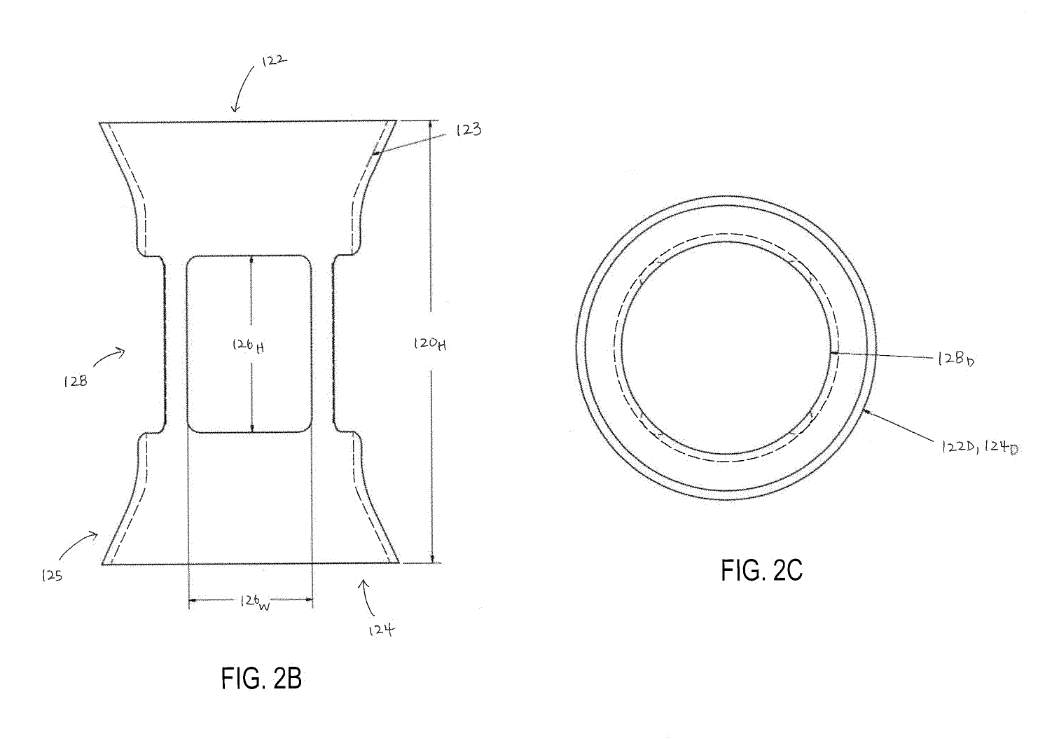

FIGS. 2A-2C provide a plurality of views of the venturi core 120. FIG. 2A illustrates a perspective view of the venturi core 120, FIG. 2B illustrates a side cross-sectional view of the venturi core 120, and FIG. 2C illustrates a top view of the venturi core 120.

In some examples, the venturi core 120 includes a tapered end 123 at the venturi input end 122 and a tapered end 125 at the venturi exit end 124. The tapered end 123 and tapered end 125 are attached to a tubular body 128 that has a diameter that is less than or equal to the narrowest portion of the tapered end 123 and tapered end 125. FIGS. 2B and 2C illustrate the attachment of the tubular body 128 to the tapered end 123 and tapered end 125 and the narrowing of the diameter. In some embodiments, the height of venturi core 120H can be 4.42 inches.

In particular, FIG. 2C illustrates a top view of the venturi core 120. As can be seen, the diameter of venturi input end 122D, the widest portion of the tapered end 123, has a greater diameter than the diameter of tubular body 128D. Similarly, the diameter of venturi exit end 124D, the widest portion of the tapered end 125, has a greater diameter than the diameter of tubular body 128D. As will be discussed in further detail below, the narrowing of the diameter of the venturi core 120 generates a venturi effect that serves to accelerate exhaust gas and encourages the flow of exhaust gas within the venturi core 120. In some embodiments, the diameter of tubular body 128D can be 2.50 inches. In some embodiments, the diameter of venturi input end 122D can be 3.00 inches. In some embodiments, the diameter of venturi exit end 124D can be 3.00 inches. In some embodiments, the diameter of venturi input end 122D and diameter of venturi exit end 124D are equivalent. In other embodiments, the diameter of venturi input end 122D and the diameter of venturi exit end 124D are different.

The venturi core 120 can include a plurality of windows 126. As will be discussed in more detail below, the plurality of windows 126 can further provide for the circulation of exhaust gas within the interior of the exhaust tube 100. In some embodiments, the width of the width of windows 126W can be 1.25 inches. In some embodiments, the height of windows 126H can be 1.75 inches.

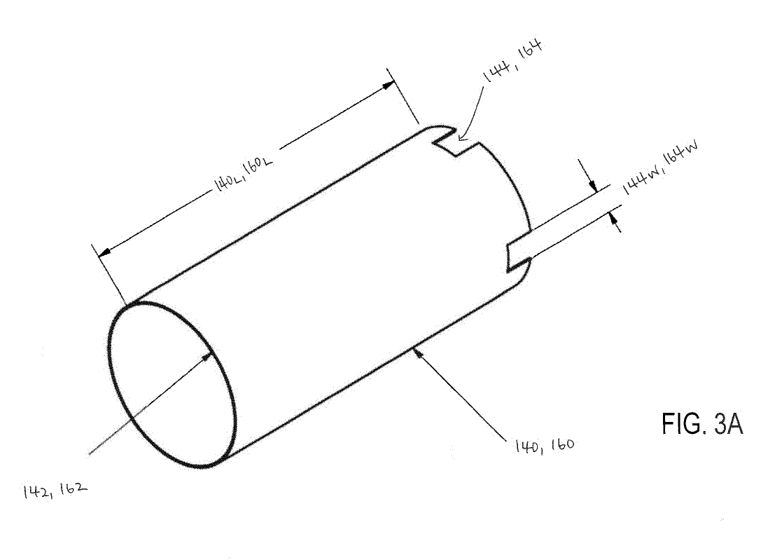

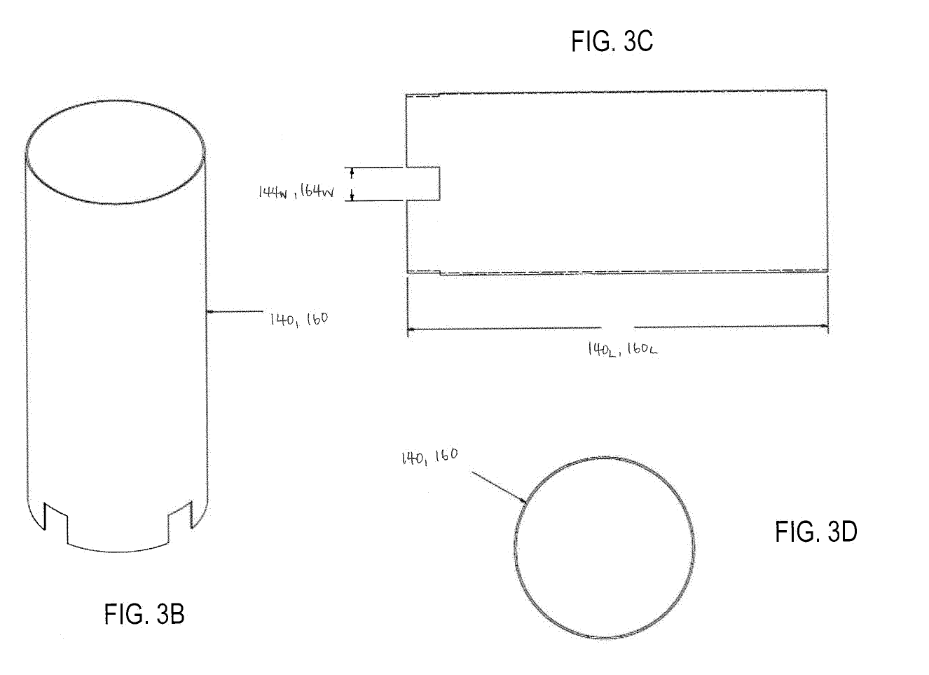

FIGS. 3A-3D illustrate a plurality of views of the exhaust tube 140, 160. FIG. 3A illustrates a perspective view of the exhaust tube 140, 160, FIG. 3B illustrates another perspective view of the exhaust tube 140, 160, FIG. 3C illustrates a side cross-sectional view of the exhaust tube 140, 160, and FIG. 3D illustrates a top view of the exhaust tube 140, 160.

Depending on the size of the vehicle, the exhaust tube 140, 160 can vary in lengths. In some embodiments, the exhaust tube 140, 160 can have a length of exhaust tube 140L, 160L that ranges from 7.75 inches.

The exhaust tube 140, 160 can include a first end 142, 162 that does not include any openings 144, 164. In some embodiments, the exhaust tube 140, 160 can include a plurality of openings 144, 164 that are located on and spaced about the circumference of a second end of the exhaust tube 140, 160. The exhaust tube 140, 160 can include 2, 3, 4, or 5 openings 144, 164 spaced about the second end of the exhaust tube 140, 160, In some examples, the openings 144, 164 can have a width 144w, 164w that is 0.55 inches. In some examples, the first exhaust tube 140 and the second exhaust tube 160 are symmetrical. In other examples, the first exhaust tube 140 and second exhaust tube 160 can vary in configuration (e.g. different lengths, diameters, number of openings, size of openings, etc.).

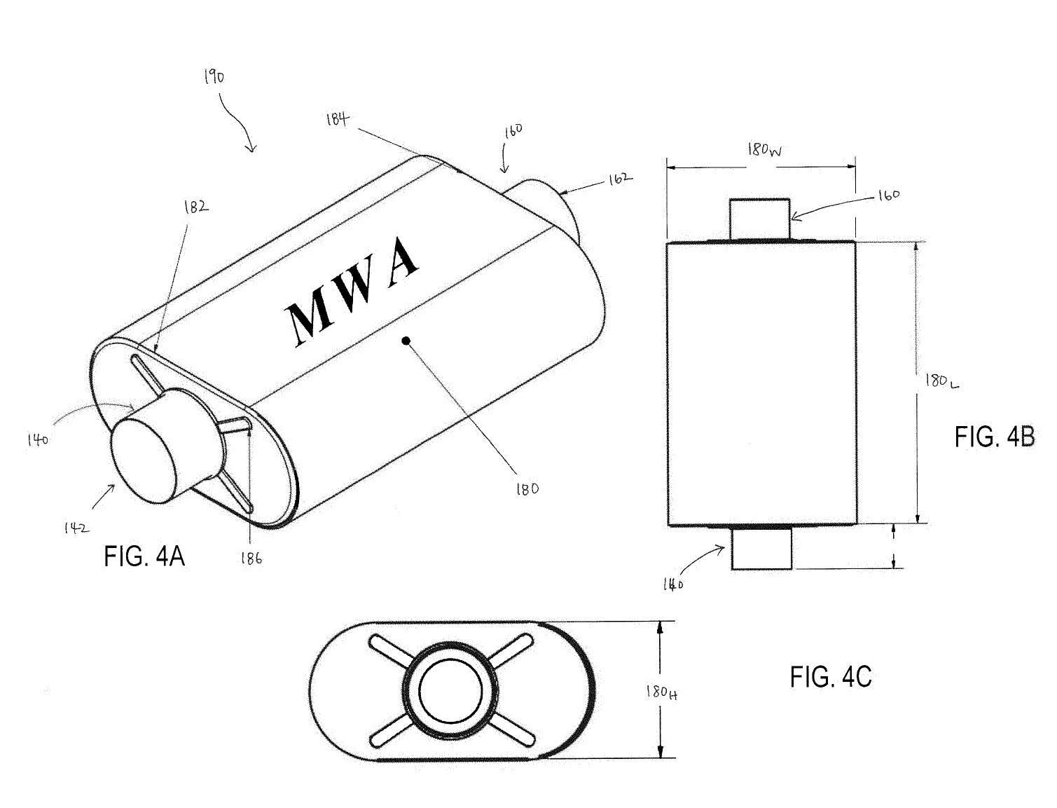

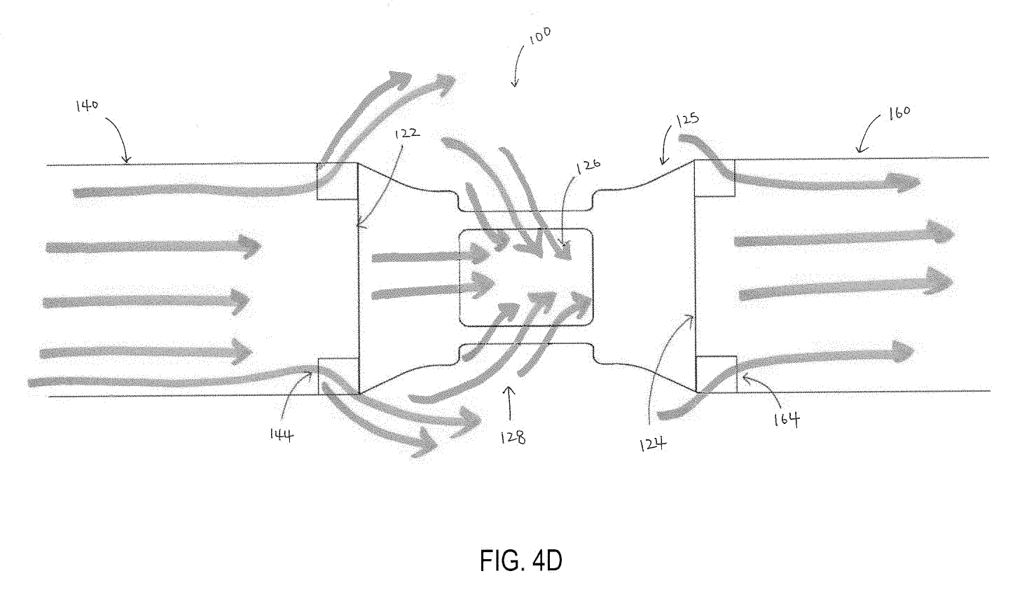

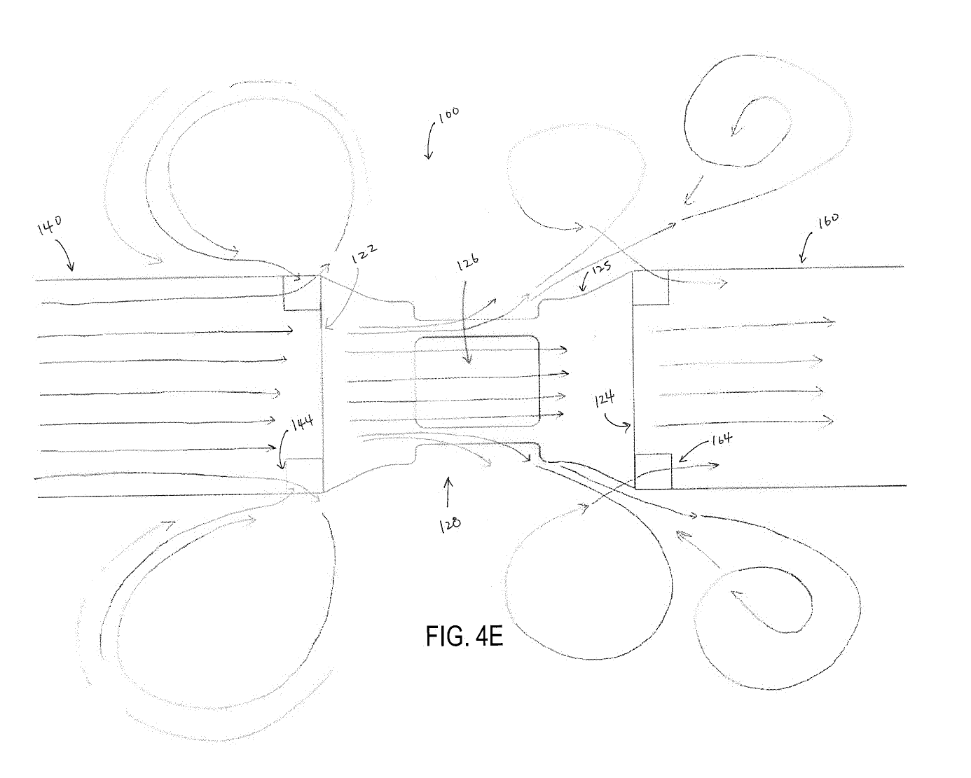

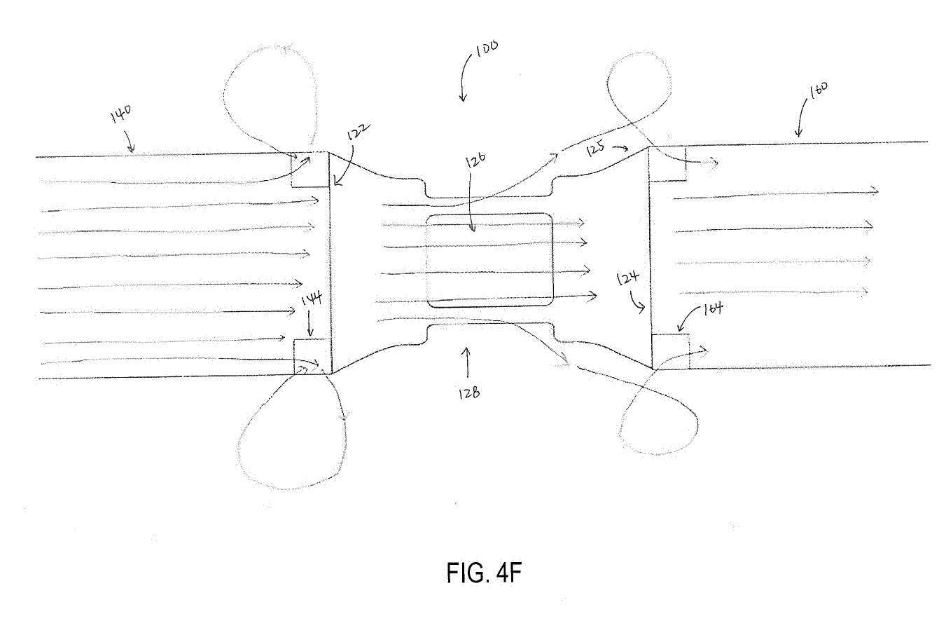

FIGS. 4A-4C illustrate an embodiment of the muffler can 180 that can be mounted about the exhaust tube 100 illustrated in FIG. 1. FIG. 4A illustrates a perspective view of the muffler assembly 190, FIG. 4B illustrates a top view of the muffler assembly 190, and FIG. 4C illustrates a front view of the muffler assembly 190.

In some examples, the exhaust tube 100 extends through the muffler can 180 such that the input end 142 and exit end 162 of the first exhaust tube 140 and second exhaust tube 160 respectively extend through the center of the muffler can 180. The muffler can 180 can include a center cap 186 on the input end 182 and on the exit end 184 that secures the exhaust tube 100 through the muffler can 180. In some examples, the center cap 186 includes an opening (not pictured) through which the input end 142 or exit end 162 of the exhaust tube 100 can extend. In some examples, the length of the exhaust tube 100 that extends from the muffler can 180 can be 3.00 inches.

The dimensions of the muffler can 180 can vary depending on the engine of the vehicle and the size of the exhaust tube 100. In some examples, the width of muffler can 180W can be 9.50 inches. In some examples, the length of muffler can 180L can be 14.00 inches. In some examples, the height of muffler can 180H can be 4.00 inches.

### Venturi Core and Fluid Dynamics

FIG. 4D provides a schematic illustration of the flow of exhaust gas through the exhaust tube 100. The exhaust lines illustrated in FIG. 4D are intended to generally illustrate the movement of air through the exhaust tube 100 and are not intended to illustrate the speed or volume of the exhaust gas flowing through the exhaust tube 100. The schematic drawing of FIG. 4D is intended to illustrate an example of the potential movement of gases through the exhaust tube 100 and is not meant to be limiting. The purpose of a muffler is generally to reduce the volume of the exhaust gas while not affecting the performance of the engine of the vehicle. The exhaust tube 100 of the muffler assembly 190 reduces the cross-sectional area of the exhaust tube 100 through use of a venturi core 120 that creates a venturi effect through the exhaust tube 100. The venturi core 120 can circulate the exhaust gas within the muffler can 180 which causes soundwave cancellation. As well, the venturi effect within the exhaust tube 100 also accelerates the flow of exhaust gas which prevents cold air external to the muffler can 180 from being sucked back into the exhaust tube 100 when a driver releases the accelerator pedal; the intake of cold air can cause a resonance and vibration that generates unwanted noise. Although not completely understood, it is believed that the mechanism of action of the exhaust tube 100 is disclosed below.

The venturi effect is the reduction in fluid pressure that results when a fluid flows through a constricted section of a pipe. The venturi effect can be illustrated by Bernoulli's principle for fluid dynamics, where ρ is the density of the fluid, v₁ is the (slower) fluid velocity where the pipe is wider, v₂ is the (faster) fluid velocity where the pipe is narrower.

ρ₁+½ρV₁²+ρgh₁=P₂+½ρV₂²+ρgh₂

Furthermore, through conservation of mass and volume, the area of the cross-section of the pipe multiplied by the velocity of the flow of fluid remains constant:

A₁υ₁=A₂υ₂

πr₁²υ₁=πr₂²υ₂

Therefore, there exists an inverse relationship between the area of a cross-section of a pipe and velocity. Given the aforementioned, conservation of mass dictates that as the area of a cross-section of a tube decreases, the velocity of the fluid increases. Bernoulli's principle further illustrates that as the velocity of the fluid increases, the static pressure decreases. Therefore, a constricted section of a pipe accelerates the flow of fluid through the constriction but also reduces the pressure within the constriction.

As applied to the exhaust tube 100 illustrated in FIG. 4D, the venturi core 120 of the exhaust tube 100 has a tapered end 123 at the venturi input end 122 that gradually reduces the diameter of the exhaust tube 100 until it reaches the tubular body 128. As exhaust gas passes from the engine into the input end 142 of the first exhaust tube 140 and travels into the venturi core 120, the reduction in diameter of the tapered end 123 of the venturi core 120 accelerates the exhaust gas through the tubular body 128 of the venturi core 120. This decrease in diameter also causes the pressure within the tubular body 128 to be at its lowest. This pressure drop within the tubular body 128 causes exhaust gas within the muffler can 180 to be drawn into the venturi core 120 from within the muffler core 180 through the windows 126 of the tubular body 128.

To allow for the added cycling of air within the muffler assembly 190, the openings 144 can allow exhaust gas to flow out of the first exhaust tube 140 into the interior of the muffler can 180. Because the pressure within the muffler can is lower than within the exhaust tube 100, some exhaust gas will be pulled out through the openings 144 of the first exhaust tube 140 as it flows through the exhaust tube 100. Thereafter, as discussed above, the drop in pressure within the tubular body 128 can draw some of this exhaust gas through the windows 126 of the tubular body 128.

Furthermore, when the flow of exhaust gas passes out of the exhaust tube 100, a vacuum is formed in the peripheral area within the exhaust tube 100. This can induce the currents of exhaust gas that escaped out of the openings 144 around the first exhaust tube 140 to be drawn into the openings 164 of the second exhaust tube 160. This enables the exhaust gas to be further carried out of the exit end 162 of the exhaust tube 100 at a high speed. The accelerated speed of the exhaust gas exiting the exhaust tube 100 can prevent outside cold air from being sucked into the exhaust tube 100 when the accelerator pedal is released. In doing so, vibration and resonance is reduced.

In some embodiments, the flow of exhaust gas through the exhaust tube 100 differs as the exhaust gas accelerates from a low speed to a high speed. Although not completely understood, it is believed that the mechanism of action of the muffler can 180 is also disclosed in FIGS. 4E-4F. FIG. 4E illustrates an example of the flow of exhaust gas through the exhaust tube 100 when the exhaust gas is travelling at a low speed and FIG. 4F illustrates an example of the flow of exhaust gas through the exhaust line when the exhaust gas is travelling at a high speed. As noted above, the exhaust lines illustrated in FIGS. 4E and 4F are intended to generally illustrate the movement of air through the exhaust tube 100 and are not intended to illustrate the speed or volume of the flow of exhaust gas. As well, the schematic drawings of FIGS. 4E-4F are intended to illustrate an example of the potential movement of gases through the exhaust tube 100 and are not meant to be limiting.

As illustrated in FIG. 4E, a large amount of exhaust gas circulates through the openings 144, 164 and the windows 126. As the speed of the exhaust gas accelerates, the exhaust gas flows much more linearly and quickly through the exhaust gas. As illustrated, much less exhaust gas escapes from the openings 144, 164 and the windows 126.

The cycling of exhaust gas within the muffler can 180 of the muffler assembly 190 can provide soundwave cancellation. When the exhaust gas is circulated in the muffler can 180, the soundwaves can be split apart and allowed to collide together again to provide sound cancellation. As the soundwave hits the interior wall of the muffler can 180, some of the soundwaves will form a counterwave that pushes back against an incoming soundwave. The location of the openings 144, openings 164, and windows 126 are designed to bounce sound around the interior of the muffler can 180 in precise ways, causing different wavelengths to cancel each other out at different points. Not only does this result in a reduction in overall sound volume, but creates a fine-tuned output tone that is rich with pleasant, low-frequency notes. The muffler assembly 190 can cause a 20-25 drop in decibels. In some embodiments, the sound generated by the muffler assembly 190 can drop in pitch. As noted above, the potential movement of gases through the exhaust tube 100 of FIGS. 4D-4F and is not meant to be limiting; further testing and research may disclose another method of action.

### Other Embodiments

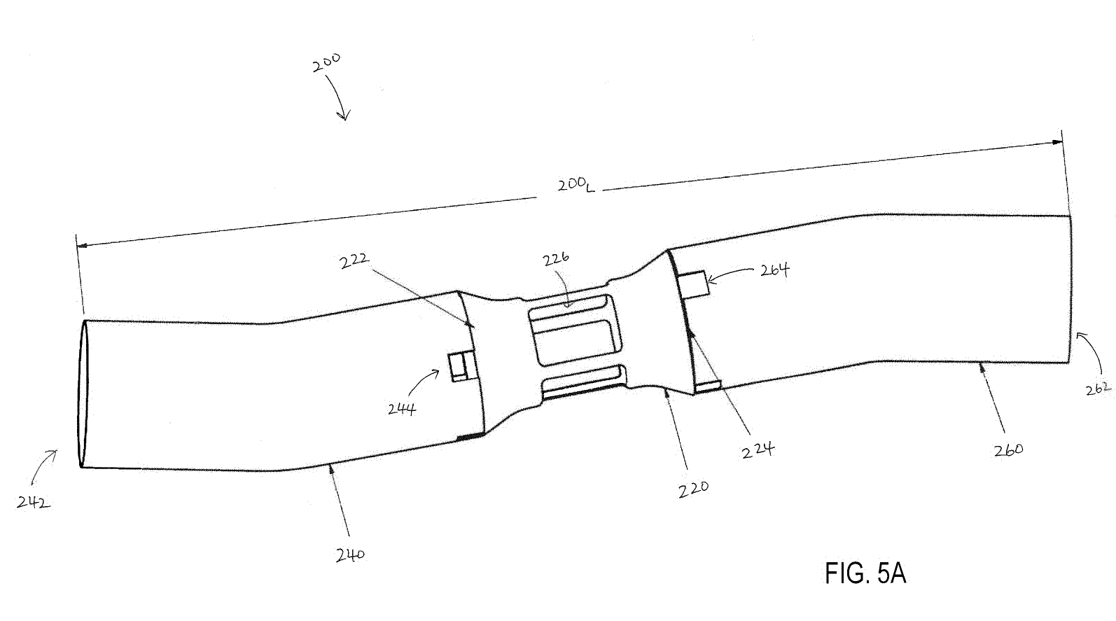

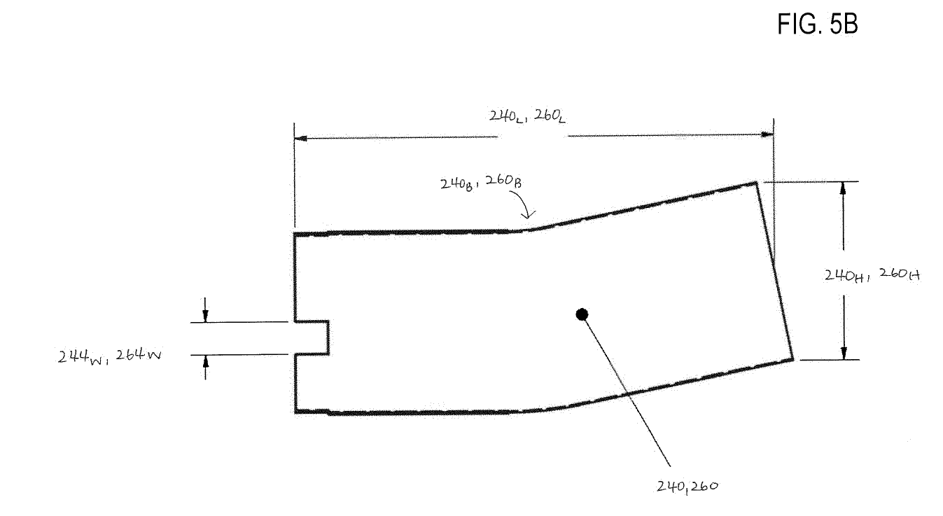

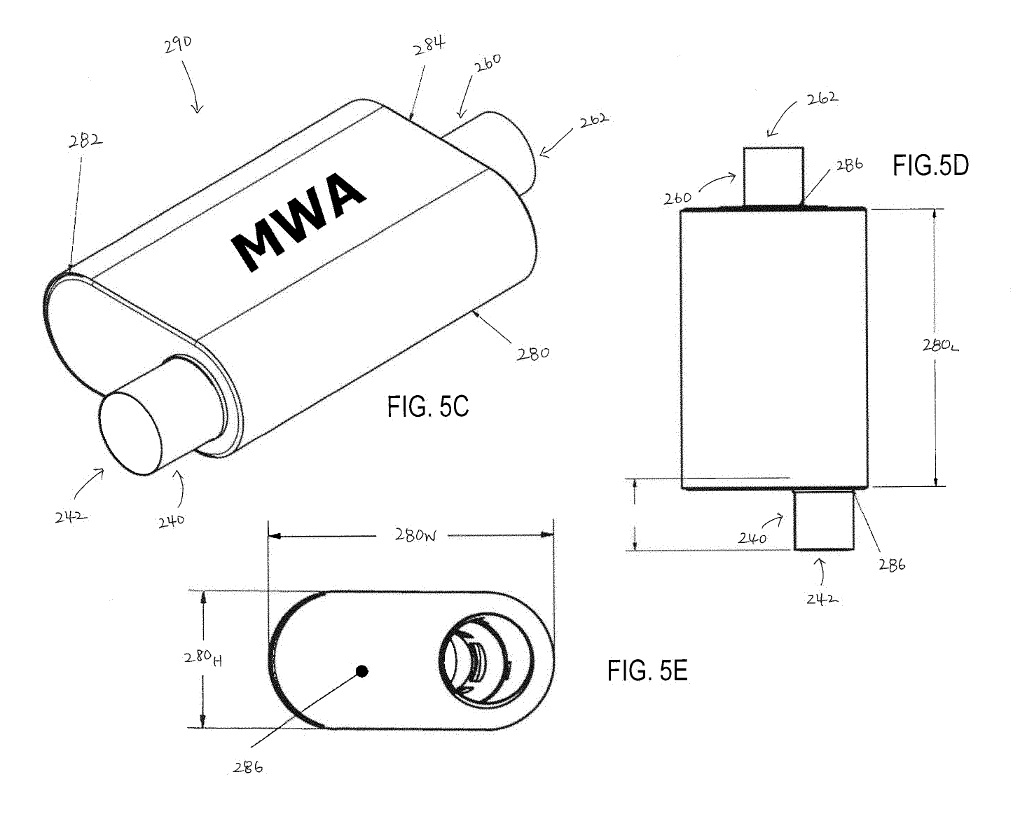

FIGS. 5A-5E, 6A-6E, 7A-7D illustrate embodiments of the exhaust line 200, 300, 400 of the muffler assembly 290, 390, 490 where the exhaust line 200, 300, 400 is offset within the muffler can 280, 380, 480. The exhaust line 200, 300, 400 is offset in order to accommodate the frame of the vehicle. However, the venturi core within each of these embodiments is identical, and the performance of the muffler assembly 290, 390, 490 is unaffected by the offset.

The exhaust line 200, 300, 400 and the muffler assembly 290, 390, 490 resemble or are identical to the exhaust tube 100 and the muffler assembly 190 in many respects. Accordingly, numerals used to identify components of the exhaust tube 100 and muffler assembly 190 are incremented by a factor of one hundred to identify like features of the exhaust line 200, 300, 400 and the muffler assembly 290, 390, 490. This numbering convention generally applies to the remainder of the figures. Any component or step disclosed, in any embodiment in this specification can be used in any other embodiments.

Turning first to FIGS. 5A-5B, the configuration of the exhaust line 200 is similar to the configuration of the exhaust tube 100 except for the bend in the first exhaust tube 240 and second exhaust tube 260. In some embodiments, the length of exhaust line 200L can be 20.00 inches. The length of exhaust tube 240L and length of exhaust tube 260L can be similar or different in length. In some embodiments, the length of exhaust tube 240L, 260L can be 7.75 inches. The height of the exhaust tube 240H, 260H can be 4.00 inches. The degree of bend 240B, 260B can be 14 degrees.

FIGS. 5C-5E illustrate an embodiment of the muffler can 280 that can be configured to accommodate the exhaust line 200. As can be seen in FIG. 5D, the exhaust line 200 can extend from the muffler can 280 through the center of the muffler can 280 at one end, and off to one side at the other end. To retain the exhaust line 200 through the muffler can 280, muffler can 280 includes a first offset cap 286 that has an opening (not shown) that is offset to one side and a second offset cap 286 that has an opening (not shown) through the center. In some embodiments, the length of muffler can 280L is 14.00 inches. In some embodiments, the width of muffler can 280W is 9.50 inches and the height of muffler can 280H is 4.00 inches. In some examples, the exhaust line 200 can extend from either end of the muffler can 280. In some examples, a length of 3.00 inches of the exhaust line 200 can extend from either or both ends of the muffler can 280.

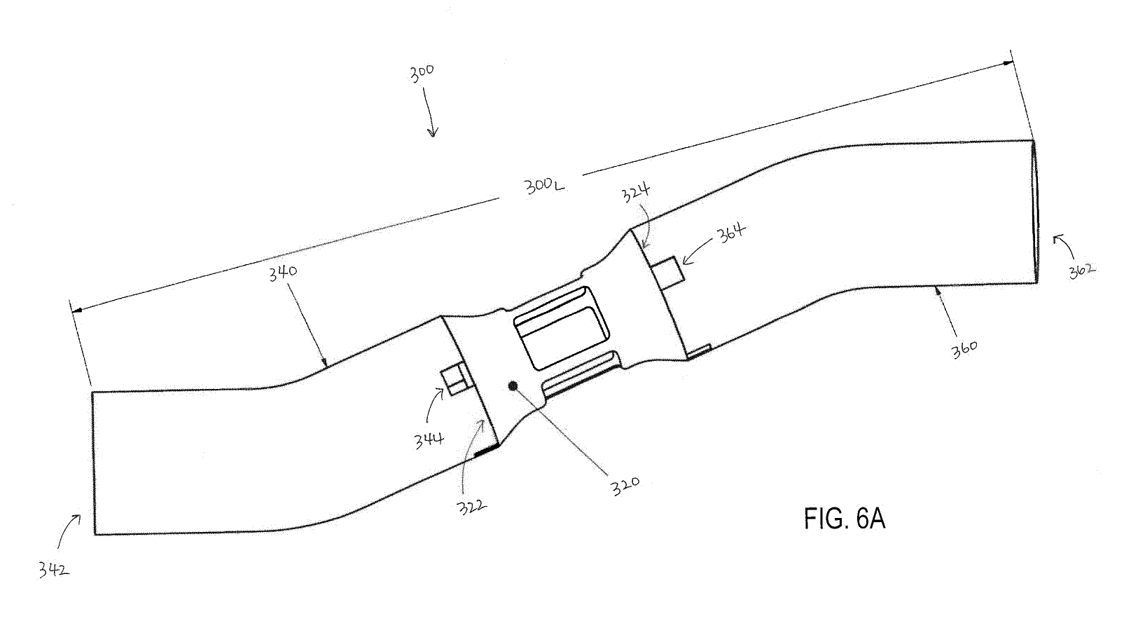

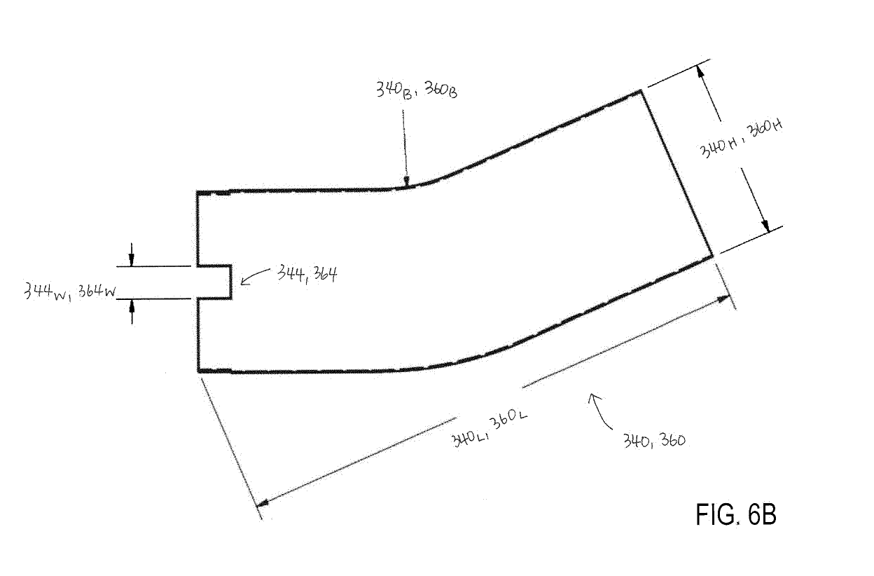

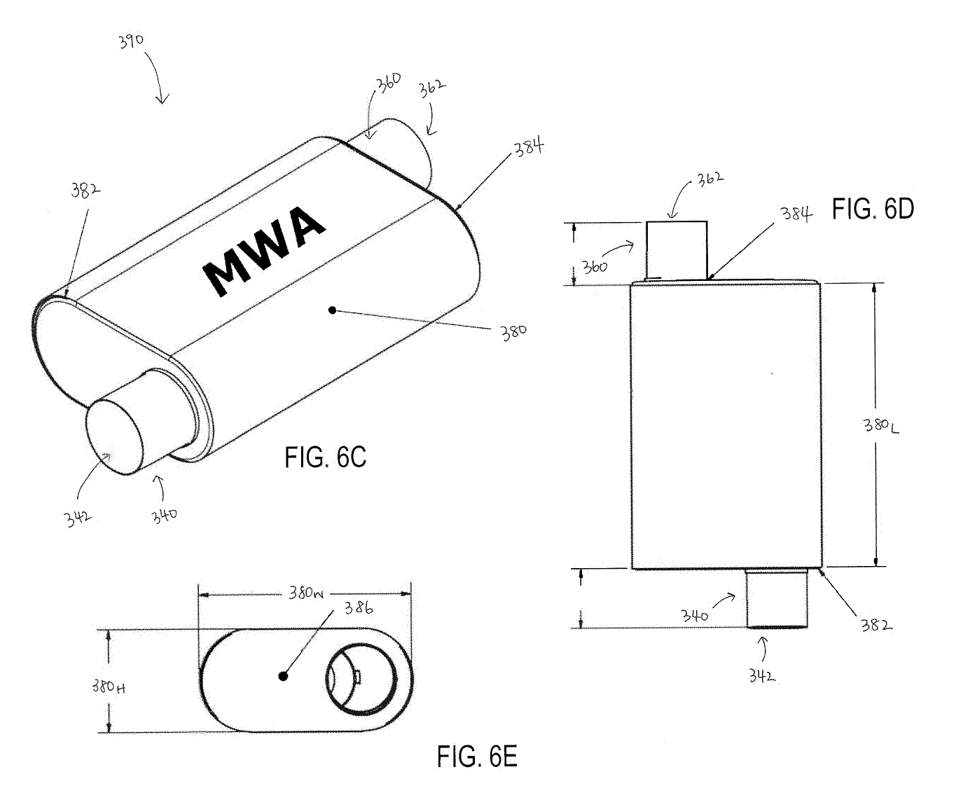

FIGS. 6A-6B illustrate another embodiment of the exhaust line 300 with a more dramatic bend. The configuration of the exhaust line 300 is similar to the configuration of the exhaust tube 100 except for the bend in the first exhaust tube 340 and second exhaust tube 360. In some embodiments, the length of exhaust line 300L can be 20.00 inches. The length of exhaust tube 340L and length of exhaust tube 360L can be similar or different in length. In some embodiments, the length of exhaust tube 340L, 360L can be 7.75 inches. The height of the exhaust tube 340H, 360H can be 3.00 inches. The degree of bend 340B, 360B can be 25.5 degrees.

FIGS. 6C-6E illustrate an embodiment of the muffler can 380 that can be configured to accommodate the exhaust line 300. As can be seen in FIG. 6D, the exhaust line 300 can extend from one side of the muffler can 380 at one and from the opposite side of the muffler can 380 at the other end. To retain the exhaust line 300 through the muffler can 380, the muffler can 380 can include a plurality of offset caps 386 that has an opening (not shown) that is offset to one side. In some embodiments, the length of muffler can 380L is 14.00 inches. In some embodiments, the width of muffler can 380W is 9.50 inches and the height of muffler can 380H is 4.00 inches. In some examples, the exhaust line 300 can extend from either end of the muffler can 380. In some examples, a length of 3.00 inches of the exhaust line 300 can extend from either or both end of the muffler can 380.

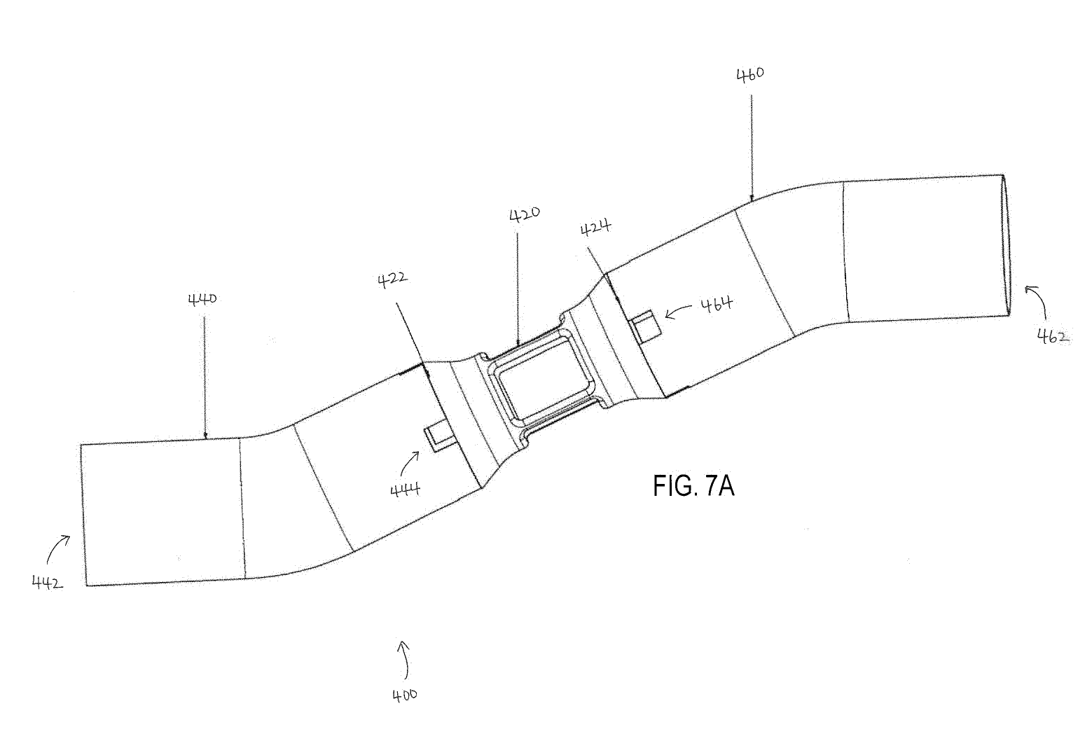

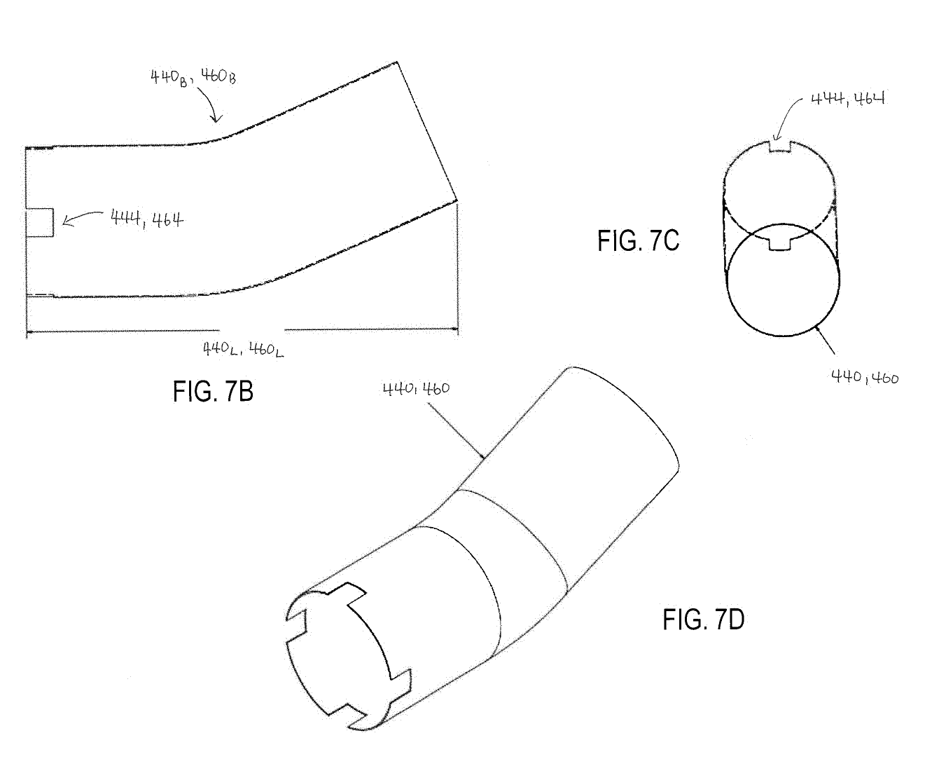

FIGS. 7A-7D illustrate another embodiment of the exhaust line 400 that also has greater bend along the length of the exhaust line 400. The configuration of the exhaust line 400 similar to the configuration of the exhaust tube 100 except for the bend in the first exhaust tube 440 and second exhaust tube 460. In some embodiments, the length of exhaust line 400L can be 20.00 inches. The length of exhaust tube 440L and length of exhaust tube 460L can be similar or different in length. In some embodiments, the length of exhaust tube 440L, 460L can be 7.75 inches. The height of the exhaust tube 440H, 460H can be 3.00 inches. The degree of bend 440B, 460B can be 25.5 degrees. In some embodiments, the exhaust line 400 can have a thickness that can range approximately between 14 gauge and 18 gauge. In some embodiments, the exhaust line 400 can have a thickness that can range approximately between 12 gauge and 20 gauge. In some embodiments, the exhaust line 400 can have a thickness between approximately 0.035 inches and 0.134 inches.

### Manufacturing

The exhaust tube 100 of the muffler assembly 190 can provide cost-effective manufacturing benefits. For example, the openings of windows 126 of the venturi core 120 can be punched out of the tubular body 128 to create a plurality of symmetrical openings in the venturi core 120. In some embodiments, the exhaust tube 100 can have a round diameter such that the exhaust tube 100 is largely symmetrical. The symmetrical design can allow the exhaust tube 100 to be engaged within the muffler can 180. The exhaust tube 100 can be manufactured from a number of different materials such as mild steel, stainless steel, or titanium.

### Certain Terminology

“Muffler” is a broad term that is to be given its ordinary and customary meaning to a person of ordinary skill in the art (i.e., it is not to be limited to a special or customized meaning) and includes, without limitation, any mechanical device that can result in sound reduction.

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, are not required to conform strictly to the mathematical definitions of the referenced structures, but can encompass structures that are reasonably close approximations.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

For expository purposes, the term “horizontal” as used herein is defined as a plane parallel to the plane or surface of the floor of the area in which the device being described is used or the method being described is performed, regardless of its orientation. The term “floor” floor can be interchanged with the term “ground.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### SUMMARY

Although exhaust lines and muffler assemblies have been disclosed in the context of certain embodiments and examples (e.g., mufflers for use in cars), this disclosure extends beyond the specifically disclosed embodiments to other alternative embodiments and/or uses of the embodiments and certain modifications and equivalents thereof. For example, any of the disclosed covers can be used on other types of vehicles or machines that require noise reduction devices. Various features and aspects of the disclosed embodiments can be combined with or substituted for one another in order to form varying modes of the conveyor. The scope of this disclosure should not be limited by the particular disclosed embodiments described herein.

Certain features that are described in this disclosure in the context of separate implementations can also be implemented in combination in a single implementation. Conversely, various features that are described in the context of a single implementation can also be implemented in multiple implementations separately or in any suitable subcombination. Although features may be described above as acting in certain combinations, one or more features from a claimed combination can, in some cases, be excised from the combination, and the combination may be claimed as any subcombination or variation of any subcombination.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying figures. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

In summary, various embodiments and examples of exhaust line, muffler assemblies, and methods for assembling have been disclosed. Although the assemblies have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described above, but should be determined only by a fair reading of the claims that follow.

What is claimed is:

1. A system for noise reduction comprising:
a tubular conduit comprising:
a first section comprising a tube with a first end and a second end and a plurality of openings spaced about the second end of the tube, wherein the first section is configured to be fluidly connected to an engine to allow exhaust gas to pass through the first section;
a second section comprising a tube with a first tapered section that reduces in diameter, a second tubular section with a plurality of openings, and a third reverse-tapered section that expands in diameter, wherein the second section is fluidly connected to the second end of the first section and is configured to accelerate the velocity of exhaust gas and decrease the pressure within the second tubular section such that exhaust gas can be drawn into the second section;
a third section comprising a tube with a first end and a second end and a plurality of openings spaced about the first end of the tube, wherein the third section is configured to be fluidly connected to the second section to allow exhaust gas to pass through the third section; and
an exterior shell disposed about the tubular conduit, wherein the exterior shell further comprises:
a first cap with an opening, wherein the first cap is configured to attach to a first end of the exterior shell and is configured to retain the first section of the tubular conduit; and
a second cap with an opening, wherein the second cap is configured to attach to a second end of the exterior shell and is configured to retain the second section of the tubular conduit.

2. A method for noise reduction comprising:
flowing air through a tubular conduit that extends through an exterior shell attached about the exterior surface of the tubular conduit, wherein the tubular conduit includes a first tubular section, a second tubular section, and a third tubular section;
flowing air through the first tubular section comprising a first end and a second end and a plurality of openings spaced about the second end of the tube;
creating a pressure drop in the second tubular section that is fluidly connected to the first tubular section, wherein a portion of the second tubular section has a reduced diameter and a plurality of openings;
flowing air through the third tubular section, comprising a first end and a second end and a plurality of openings spaced about the first end of the tube, wherein the first end of the third tubular section is fluidly connected to the second tubular section;
causing air to flow out of the plurality of openings in the first tubular section;
causing air to flow into the plurality of openings in the second tubular section as a result of the pressure drop within the second tubular section;
causing air to flow into the plurality of openings in the third tubular section;
bouncing soundwaves against the inner surface of the exterior shell to create counterwaves that cause sound cancellation; and
forcing air out of the second end of the third tubular section.
